(19) United States
(12) Patent Application Publication
(10) Pub. No.: US 2007/0156776 A1
(43) Pub. Date: Jul. 5, 2007

(54) Change documents and method

(76) Inventors: Raja Krishnamoorthy, Bangalore (IN); Kritesh Vasing, Bangalore (IN); Sumana Chakraborty, Bangalore (IN); Kai Uwe Pielka, Reilingen (DE)

Correspondence Address: SCHWEGMAN, LUNDBERG, WOESSNER & KLUTH, P.A., P.O. BOX 2938, MINNEAPOLIS, MN, 55402, US

(21) Appl. No.: 11/322,640

(22) Filed: Dec. 30, 2005

(51) Int. Cl. G06F 17/30

(52) U.S. Cl. 707/201

(57) ABSTRACT

A system includes a general business object, a platform change business object, and a change agent associated with the business object that detects a change in the general business object and creates a platform change document in the platform change business object.

### BACKGROUND

Many businesses are now required to keep an audit trail for many aspects of the business. In some instances this need is dictated by accounting practices, such as the general rules for accounting. In other instances, a business needs to keep an audit trail in order to meet legal requirements. For example, the Sarbanes Oaxley Act requires that an audit trail must be kept within a business. The Internal Revenue Service also requires that an audit trail be maintained. In addition, other governmental bodies also requires that an audit trail be maintained. In still other instances, there is a need for an audit trail in manufacturing situations. For example, the Federal Food and Drug Administration in the United States requires that an audit trail be kept regarding the manufacture of pharmacuticals. With such an audit trail, the manufacturer can detect if changes occurred if a portion of a manufactured product was determined to be harmful.

### BRIEF DESCRIPTION OF THE DRAWINGS

FIG. 1 is a block diagram of an overall computing environment, according to an example embodiment.

FIG. 2 is a display of a model of a business object, according to an example embodiment.

FIGS. 3A, 3B, and 3C form FIG. 3 which is a schematic view of a portion of the computing environment that includes a platform change business object, according to an example embodiment.

FIG. 4 is a schematic of a portion of a database that includes a plurality of platform change documents in a platform change business object, according to an example embodiment.

FIG. 5 is a model of a platform change business object, according to an example embodiment.

FIG. 6 is a flow diagram of a method for producing a platform change business object, according to an example embodiment.

FIG. 7 is a flow diagram of a method for reconstruction of a historical state of a business object, according to an example embodiment.

FIG. 8 is a flow diagram of a method for querying a first platform change business object and a second platform change business object, according to an example embodiment.

FIG. 9 is a flow diagram of another method for producing a platform change business object, according to an example embodiment.

FIG. 10 is a schematic of a computer system that executes programming, according to an example embodiment.

### DETAILED DESCRIPTION

In the following description, reference is made to the accompanying drawings that form a part hereof, and in which is shown by way of illustration specific embodiments which may be practiced. These embodiments are described in sufficient detail to enable those skilled in the art to practice the invention, and it is to be understood that other embodiments may be utilized and that structural, logical and electrical changes may be made without departing from the scope of the present invention. The following description is, therefore, not to be taken in a limited sense, and the scope of the present invention is defined by the appended claims.

The functions or algorithms described herein are implemented in software or a combination of software and human implemented procedures in one embodiment. The software comprises computer executable instructions stored on computer readable media such as memory or other type of storage devices. The term “computer readable media” is also used to represent carrier waves on which the software is transmitted. Further, such functions correspond to modules, which are software, hardware, firmware or any combination thereof. Multiple functions are performed in one or more modules as desired, and the embodiments described are merely examples. The software is executed on a digital signal processor, ASIC, microprocessor, or other type of processor operating on a computer system, such as a personal computer, server or other computer system.

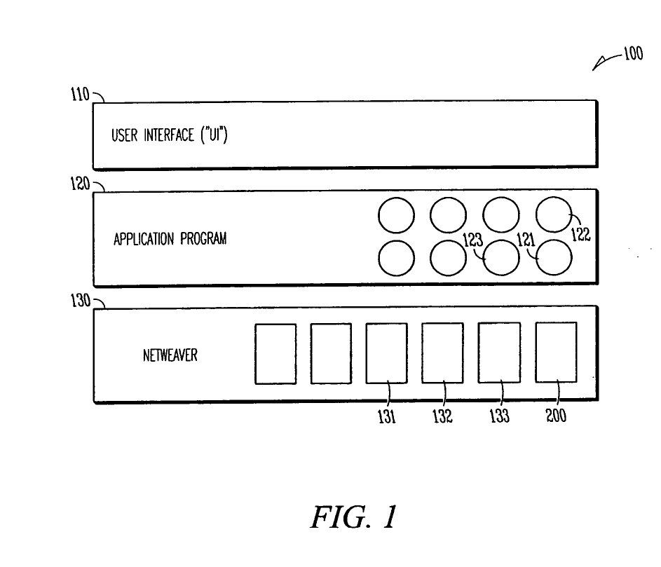

FIG. 1 is a block diagram of a computing system 100, according to an example embodiment. The computing environment 100 includes a user interface 110, an application program level 120 and a comprehensive integration and application platform layer 130. The comprehensive integration and application platform layer works with an existing infrastructure to enable and manage change. The comprehensive integration and application platform 130 includes a plurality of business applications, known as business components, which reduce the need for custom integration. The comprehensive integration and application platform includes a business component 131, 132, and 133. The comprehensive integration and application platform 130 also includes a business component 200, which includes various integration tools for performing business analysis on business information within the computing environment 100. The application program layer 120 also includes a number of distributed objects 121, 122, 123. The object is a technical representation of a concept that includes data and logic. In one example embodiment, the object, such as object 131, 132, 133 is referred to as a business object and is a technical representation of a business concept that includes data and logic.

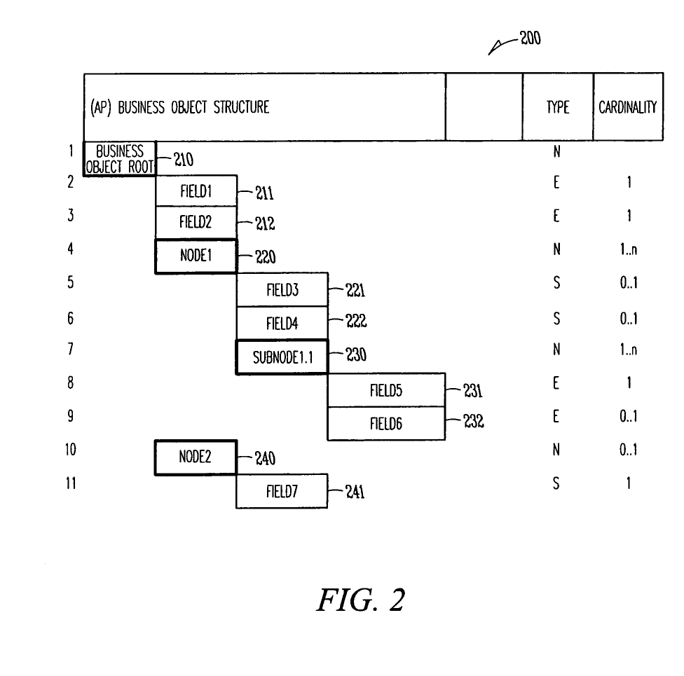

FIG. 2 is a display of a model 200 of a business object, such as business object 121, according to an example embodiment. A business object or object has a structure that includes a root 210, nodes such as nodes 220 and 240, and a sub node 230. Associated with a business or a root 210 is a grouping of information related to the business object root or root 210. Some of the information is held in fields such as 211 and 212. The information is also held in a node 220 which in turn also represents a grouping of information such as data and logic which are held in fields 221 and 222. Also under the root 210 and node 220 is a sub node 230. Sub node 230 holds another grouping of information that includes data and logic that are held in fields 231, 232. The business object 200 also includes another node 240. Node 240 is at the same level as node 220 and includes another grouping of data and logic which includes field 241. Therefore, it is seen that object 200 or business object 200 has a structure which includes a root 210, nodes, such as nodes 230 and 240, and sub nodes, such as sub node 230. It should be noted that FIG. 2 shows a simplified example of the structure of an object or business object 200. In actuality, a business object or object 200 may have a more complex structure. However, the principles as set forth in FIG. 2 will be followed where each root, node and/or sub node includes a grouping of information that can include data and logic.

In some embodiments, the structure of the business object or an outline of the business object is used to form a model of the business object 200. A model is useful for the purposes of designing and programming in a business object, such as business object 200. A model of the business object 200 shows the structure. In some embodiments, the model is referred to as a template. A template or model can take on any form just so it shows the structure of the object or business object 200. As shown in FIG. 2, the template is formed on a spreadsheet, such as an Excel spreadsheet. Excel is a registered trademark of Microsoft Corporation.

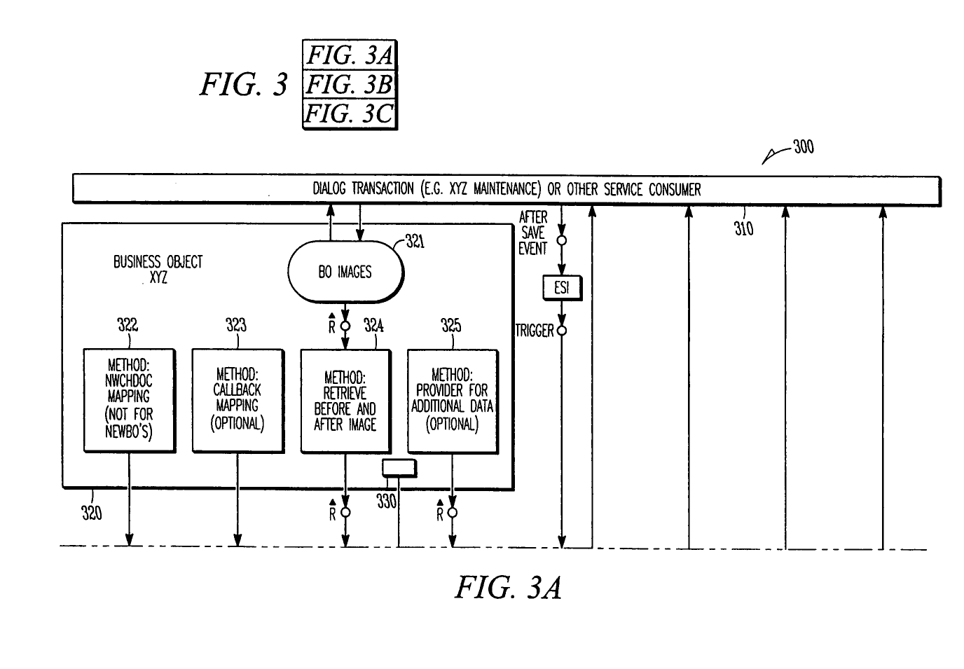

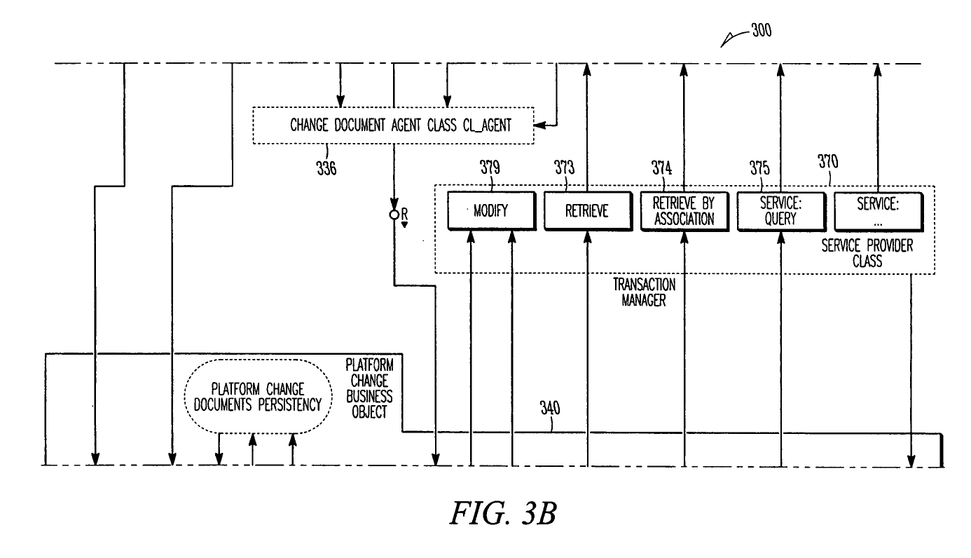

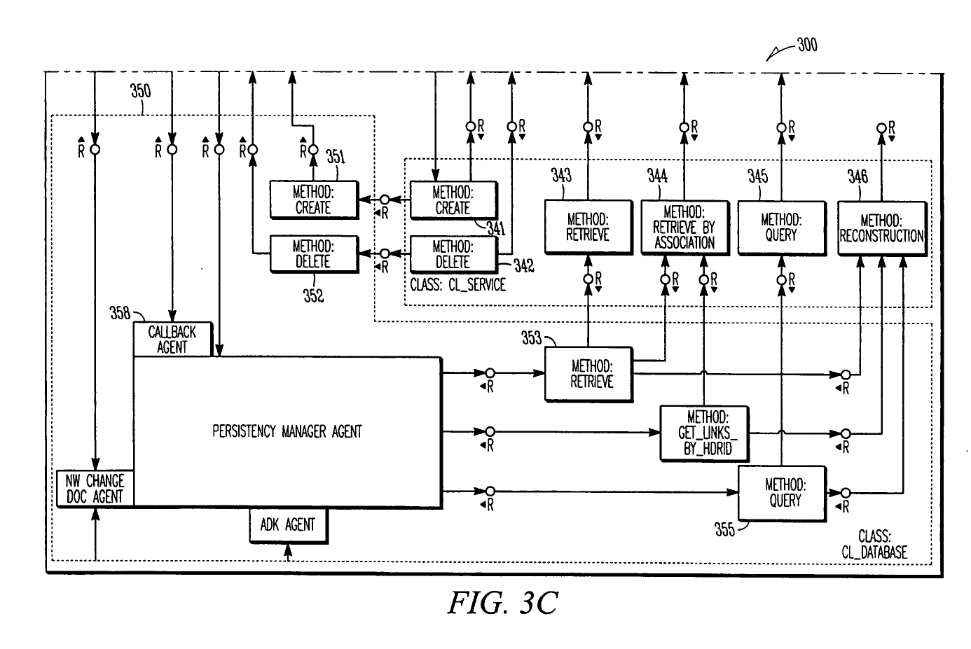

FIGS. 3A, 3B and 3C form FIG. 3 which is a schematic view of a portion of a computing environment 300 that includes a user interface 310, a business object 320, and a platform change business object 340. The portion of the computing environment 300 also includes a change document agent 336 which is associated with the business object 320. The business object 320 includes an interface to the user interface 310. Through the user interface 310, various images from a BO image module 321 may be viewed. The business object 320 also includes processes or methods for document mapping 322, call back mapping 323, retrieving before and after images 324, and for providing additional data 325. The business object 320 also includes a switch or enablement device for enabling the change document agent 336. When enabled, the change document agent 336 detects changes in the business object 320 and signals the platform change business object 340 of those changes. The platform change business object creates a platform change document in response to the change document agent detecting a change in the business object 320. The change document agent 336 alerts a create process 341 within the platform change business object 340. The create process 341 creates a platform change document in a portion of a database 350 which is controlled or within the platform change business object 340.

The platform change business object 340 also includes a process for deleting information 342, a method or process for retrieving information 343, a method for retrieving by association 344, a method for querying 345, and a method for reconstruction 346. The portion of the database 350 also includes a method for creation 351, a method for deletion 352, a method or process for retrieving 353, and a method for querying 355. The method to retrieve by association 344 is connected to the method to retrieve 353 found in the portion of the database 350. The database portion of the platform change business object 340 also includes a call back agent 358 for obtaining additional information from the business object 320. Thus, in operation when the switch 330 is enabled to enable the change document agent 336, changes in the business object 320 are detected and in response to the detected changes, a platform change document is created in the platform change business object 340. Specifically, the change document agent 336 calls a create process 341 within the platform change business object which in turn enables the platform change document to be created in the database 350 or portion of the database 350 associated with the platform change business object 340.

The portion of the computing environment 300 also includes a transaction manager 370. The transaction manager 370 includes services that interact with the user interface 310. Such services include a retrieve process 373, a retrieve by association process 374 and a query process 375. The transaction manager 370 also includes other services that may be provided in the future or may be provided for interacting with the user interface 310 in other systems. The transaction manager 370 also includes a modifying method 379 that interacts with the create method 341 and the delete method or process 342 of the platform change business object 340. It should be noted that the business object 320 may be referred to as a general business object since it is not specific to any particular application process or information but is applicable to any business object in a computer system such as system 100 (see FIG. 1).

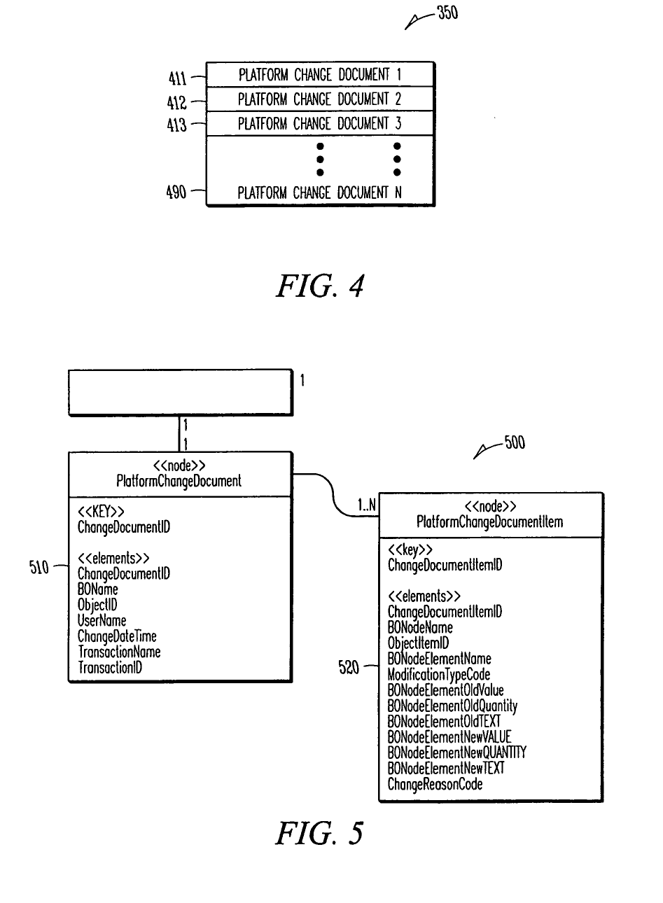

FIG. 4 is a schematic of a portion of a database 350 that includes a plurality of platform change documents 411, 412, 413 and 490. For every change that occurs in the business object 320, a platform change object is produced and stored in the database portion 350 of the platform change business object 340. Thus, there may be n number of changes that occur since the change document agent 336 (see FIG. 3) is enabled. It should be noted that some business objects or in some systems the change document agent 336 is enabled at the time of production of the system. In other words, an end user would have to disable the change document agent 336. In the absence of disabling the change document agent 336, the change document agent 336 will create platform change documents, such as 411, 412, 413, 490 in a portion of the database 350 of the platform change business object 340.

Platform change documents are maintained as a business object. FIG. 5 is a model 500 of a platform change business object 340, according to an example embodiment. The platform change documents object includes a first node 510 and a second node 520. The first node 510 contains or carries the header attributes. The second node 520 carries the item attributes. The header node or the first node 510 contains the header, and respective root node of the platform change documents business objects and also provides the following elements:
ChangeDocumentID=GUID which identifies a Platform Change Document
BOName=Name respectively type of the Business Object which was changed
ObjectID=Identifier of the instance of the Business Object which was changed
UserName=Name of the Individual who changed the Business Object instance
ChangeDateTime=Date and Time of the Change in UTC
TransactionName=Name of the transaction which was used to change the Business Object instance
TransactionID=Identifier of the instance of the transaction which was used to change the Business Object instance

PlatformChangeDocumentitem is the item of a Platform Change Document. For every element which was changed in a Business Object instance, one PlatformChangeDocumentitem node is created. It provides the following elements:
a. ChangeDocumentItemID=GUIID which identifies the item of a Platform Change Document
b. BONodeName=Node of the Business Object which contains the element whose instance was changed
c. ObjectItemID=Identifier of the Node
d. BONodeElementName=Name of the element whose instance was changed
e. Modification TypeCode=Defines whether the Business Object Instance was Created, Updated or Deleted
f. BONodeElementOldValue=Old Value of the instance of the element which was changed. This field is only used if the corresponding field in the BO is a value field with a currency code assigned
g. BONodeElementOldQuantity=Old Value of the instance of the element which was changed. This field is only used if the corresponding field in the BO is a value field with a currency code assigned
h. BONodeElementOldText=Old Value of the instance of the element which was changed. This field is used for all other data types. For convenience of the Business Objects, also the value of BONodeElementOldValue or BONodeElementOldQuantity is copied into BONodeElementOldText
i. BONodeElementNewValue=New Value of the instance of the element which was changed. This field is only used if the corresponding field in the BO is a value field with a currency code assigned.
j. BONodeElementNewQuantity=New Value of the instance of the element which was changed. This field is only used if the corresponding field in the BO is a quantity field with a Unit of Measure code assigned.
k. BONodeElementNewText=New Value of the instance of the element which was changed. This field is used for all other data types. For convenience of the Business Objects, also the value of BONodeElementOldValue or BONodeElementOldQuantity is copied into BONodeElementOldText.
l. ChangeReasonCode=Reason for the change

A system 300 includes a general business object 320, a platform change business object 340, and a change agent 336 associated with the general business object 320 that detects a change in the general business object 320 and creates a platform change document 500 in the platform change business object 340. The change agent 336 automatically creates a platform change document 500 in the platform change document business object 340 in response to detecting a change in the general business object 320. The system 300 is an enablement device, such as a switch 330. The enablement device 330 enables the change agent 336 to automatically create a platform change document 500 in the platform change business object 310 in response to detecting a change in the general business object 320. The system 300 can also include a transaction control or transaction manager 370. In one embodiment, the enablement device 330 acts through the transaction control 370. The platform change business object 340 includes a change time and a change date and other attributes as discussed with respect to FIG. 5. The platform change document 500 in the platform change business object 340 tracks the changes to the general business object 320. The platform change business object 340 includes a callback agent 358 to enable the callback agent to populate the platform change business object 340 with selected attributes.

A platform change apparatus includes a mechanism for detecting changes in a general business object 320 and automatically recording the changes in a platform change business object 340. The platform change business object 340 includes a platform change document 500 related to a change in the general business object 320. The platform change business object 340 stores the changes to the general business object 320. The system 300 also includes a reconstruction device or reconstruction process 346 that retrieves the general business object 320 in a current state and applies changes made to the general business object 320 and recorded in the platform change business object 340 to the retrieved current state to reconstruct the general business object 320 in a desired historic state. The change agent 336 of the system 300 automatically creates a platform change document in the platform change document business object 340 in response to detecting a change in the general business object 220. The platform change document 500 includes the changes made at a selected time. The call back system or agent 358 retrieves additional information from the general business object 320 which, in some embodiments, is used to create a previous state of the general business object 320.

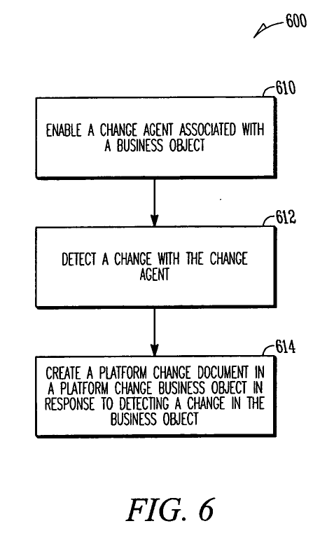

FIG. 6 is a flow diagram of a method 600 for producing a platform change business object 614, according to an example embodiment. The method 600 includes enabling a change agent associated with a general business object 610, detecting a change with the change agent 612, and creating a platform change document in a platform change business object in response to detecting a change in the general business object 614. Detecting a change 612 and creating a platform change document in a platform change business object 614 is done automatically. Creating a platform change document in a platform change business object 614 includes placing transaction identifying information in the platform change document, indicating a type of modification in the platform change document, placing old information in the platform change document, placing new information in the platform change document, placing a date associated with a change in the platform change document, and placing comments for the change in the platform change document. Other items can also be changed or noted in the created platform change document 500. In addition, the call back agent 358 (see FIG. 3), in some embodiments, will call back to the general business object 320 to obtain further attributes associated with the general business object 320.

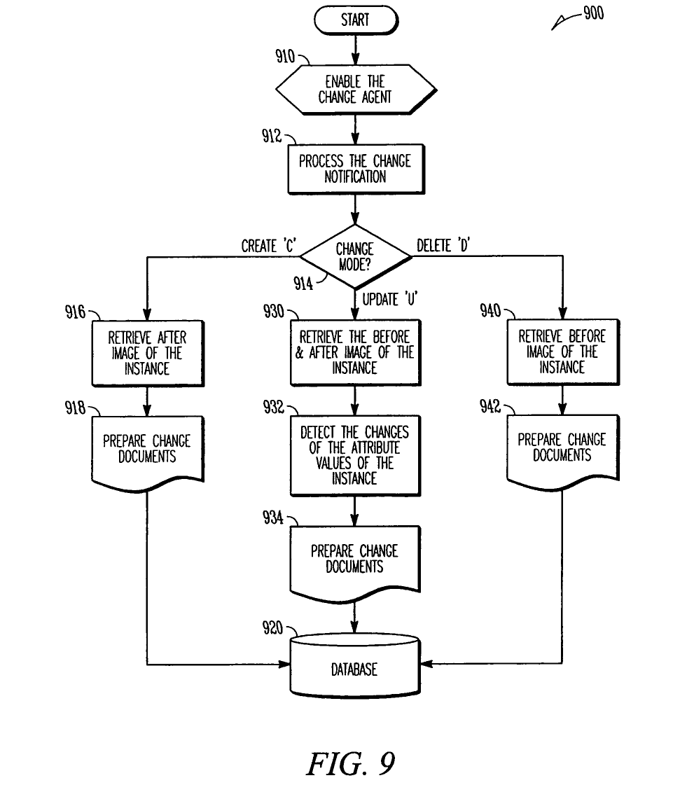

FIG. 9 is a flow diagram of another method 900 for producing a platform change business object that includes platform change documents, according to another example embodiment. The method 900 includes enabling the change agent 910, and processing the change notification 912. The change mode is determined as depicted by decision box 914. If the change is a create type of change, the method 900 includes retrieving the after image of the instance 916, and preparing the platform change documents 918 and storing the change documents in a database 920. A platform change business object, in one example embodiment, controls the storage of the platform change documents in the database. If the change mode is an update type of change, the method 900 includes retrieving the before and after image of the instance 930, detecting the changes of the attribute valudes of the instance 932, and preparing the platform change documents 934 and storing the change documents in a database 920. If the change is a delete type of change, the method 900 includes retrieving the before image of the instance 940, and preparing the platform change documents 942 and storing the change documents in a database 920.

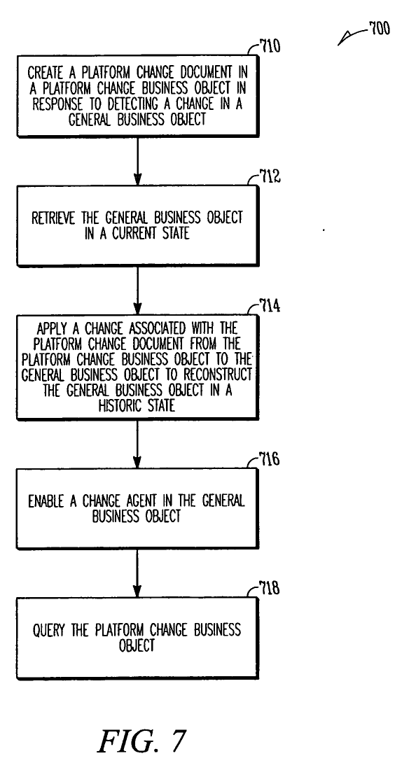

FIG. 7 is a flow diagram of a method 700 for reconstruction of a historical state of a business object, according to an example embodiment. The method 700 includes creating a platform change document in a platform change business object in response to detecting a change in a general business object 710, retrieving the general business object in a current state 712, applying a change associated with the platform change document from the platform change business object to the general business object to reconstruct the general business object in a historic state 714. The method 700 further includes enabling a change agent in the general business object 710. Applying the change associated with the platform change document in a platform change business object includes applying a plurality of changes in an order where the latest change is first applied. In some embodiments, applying the change associated with the platform change document in a platform change business object includes applying a plurality of changes in a reverse time order. The method 700 also includes querying the platform change business object 718. The query can includes a general business object name, a user name, a date timestamp, and the like. The method also includes querying the platform change business object and querying the general business object with the same query system. In some embodiments, the platform change business object includes a call back agent or system 358 that retrieves additional data from the general business object 320.

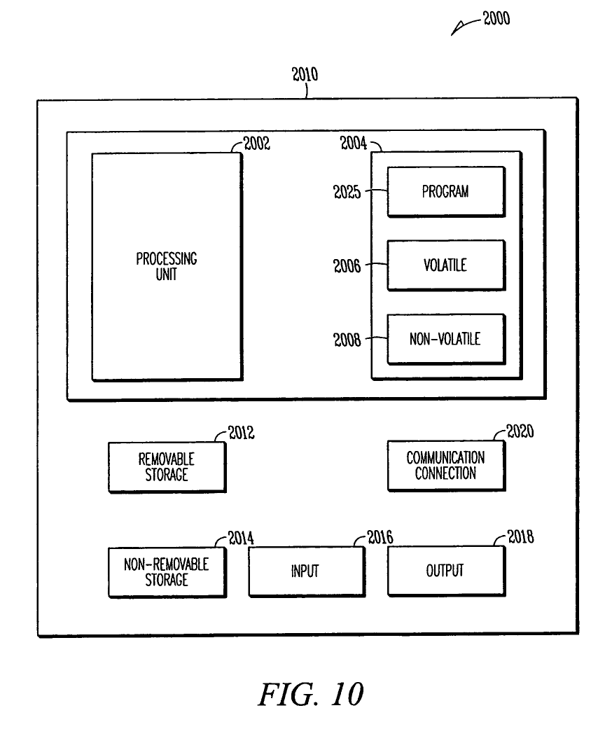

The platform change business object 340 is structured and modeled in the same fashion as any other business object in the computing environment 100 (see FIG. 1). As a result, the systems and processes that apply to any object or business object in the computing environment 100 (see FIG. 1) also applies to the platform change documents business object 340. For example, the platform change business object 340 can be queried using the query process 375 in the transaction manager as well as the query process 345, which is found in the platform change business object 340. The queries can be made through the user interface 310. Queries can include the querying of a platform change document based upon the business object name, the outcome of the object ID, the user name of the person who made the change, the changed date, time, the transaction name or a transaction ID. In other words, all of the elements in the header node 510 (see FIG. 10) can be used to form a query. It should also be noted that several business objects may have their change document agent, such as change document agent 336, enabled. In this particular instance, then a platform change business object 340 could include platform change documents from one of several business objects or one of several general business objects. Again, the querying process 375, 345 can be used to query various aspects of the platform change business object 340.

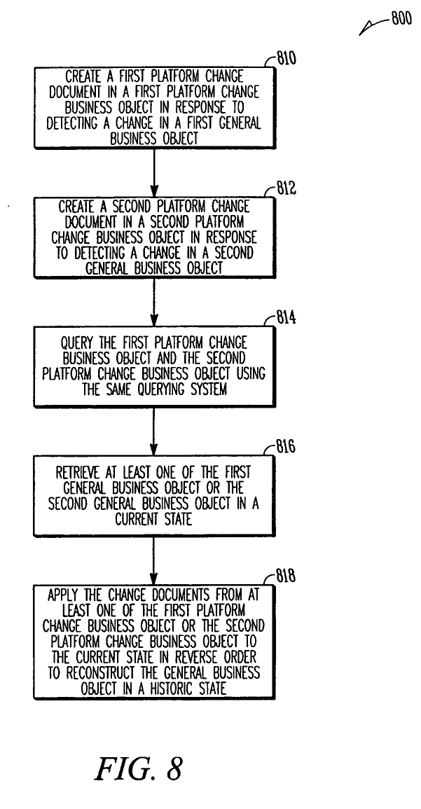

FIG. 8 is a flow diagram of a method 800 for querying a first platform change business object and a second platform change business object, according to an example embodiment. The method 800 includes creating a first platform change document in a first platform change business object in response to detecting a change in a first general business object 810, creating a second platform change document in a second platform change business object in response to detecting a change in a second general business object 812, and querying the first platform change business object and the second platform change business object using the same querying system 814. The querying system can also be used to query a first business object and a second business object. The method 800 also includes retrieving at least one of the first general business object or the second general business object in a current state 816. The method also includes applying the change documents from at least one of the first platform change business object or the second platform change business object to the current state in reverse order to reconstruct the general business object in a historic state 818.

A block diagram of a computer system 2000 that executes programming for performing the above algorithm is shown in FIG. 10, according to an example embodiment. A general computing device in the form of a computer 2010, may include a processing unit 2002, memory 2004, removable storage 2012, and non-removable storage 2014. Memory 2004 may include volatile memory 2006 and non-volatile memory 2008. Computer 2010 may include—or have access to a computing environment that includes—a variety of computer-readable media, such as volatile memory 2006 and non-volatile memory 2008, removable storage 2012 and non-removable storage 2014. Computer storage includes random access memory (RAM), read only memory (ROM), erasable programmable read-only memory (EPROM) & electrically erasable programmable read-only memory (EEPROM), flash memory or other memory technologies, compact disc read-only memory (CD ROM), Digital Versatile Disks (DVD) or other optical disk storage, magnetic cassettes, magnetic tape, magnetic disk storage or other magnetic storage devices, or any other medium capable of storing computer-readable instructions. Computer 2010 may include or have access to a computing environment that includes input 2016, output 2018, and a communication connection 2020. The computer may operate in a networked environment using a communication connection to connect to one or more remote computers. The remote computer may include a personal computer (PC), server, router, network PC, a peer device or other common network node, or the like. The communication connection may include a Local Area Network (LAN), a Wide Area Network (WAN) or other networks.

Computer-readable instructions stored on a computer-readable medium are executable by the processing unit 2002 of the computer 2010. A hard drive, CD-ROM, and RAM are some examples of articles including a computer-readable medium. For example, a computer program 2025 capable of providing a generic technique to perform access control check for data access and/or for doing an operation on one of the servers in a component object model (COM) based system according to the teachings of the present invention may be included on a CD-ROM and loaded from the CD-ROM to a hard drive. The computer-readable instructions allow computer system 2000 to provide generic access controls in a COM based computer network system having multiple users and servers.

A machine-readable medium including a set of instructions that, when executed by a machine, perform a method that includes enabling a change agent associated with a general business object 610, detecting a change in the general business object with the change agent 612, and creating a platform change document in a platform change business object in response to detecting a change in the general business object 614.

A machine-readable medium including a set of instructions that, when executed by a machine, perform the method that includes creating a platform change document in a platform change business object in response to detecting a change in a general business object 710, retrieving the general business object in a current state 712, applying a change associated with the platform change document from the platform change business object to the general business object to reconstruct the general business object in a historic state 714.

A machine-readable medium including a set of instructions that, when executed by a machine, perform the method that includes creating a first platform change document in a first platform change business object in response to detecting a change in a first general business object 810, creating a second platform change document in a second platform change business object in response to detecting a change in a second general business object 812, and querying the first platform change business object and the second platform change business object using the same querying system 814.

The Abstract is provided to comply with 37 C.F.R. § 1.72(b) to allow the reader to quickly ascertain the nature and gist of the technical disclosure. The Abstract is submitted with the understanding that it will not be used to interpret or limit the scope or meaning of the claims.

1. A system comprising:
a general business object;
a platform change business object; and
a change agent associated with the business object that detects a change in the general business object and creates a platform change document in the platform change business object.

2. The system of claim 1 wherein the change agent automatically creates a platform change document in the platform change document business object in response to detecting a change in the general business object.

3. The system of claim 1 further comprising an enablement device, wherein the enablement device enables the change agent to automatically create a platform change document in the platform change business object in response to detecting a change in the general business object.

4. The system of claim 3 wherein enablement device is a switch.

5. The system of claim 3 further comprising a transaction control, wherein the enablement device acts through the transaction control.

6. The system of claim 1 wherein the platform change business object includes a change time and a change date.

7. The system claim 1 wherein the platform change document in the platform change business object tracks the changes to the general business object.

8. The system claim 1 wherein the platform change business object includes a callback agent to enable the callback agent to populate the general business object with selected attributes.

9. A method comprising:
enabling a change agent associated with a general business object;
detecting a change with the change agent; and
creating a platform change document in a platform change business object in response to detecting a change in the general business object.

10. The method of claim 9 wherein detecting a change and creating a platform change document in a platform change business object is done automatically.

11. The method of claim 9 wherein creating a platform change document in a platform change business object includes placing transaction identifying information in the platform change document.

12. The method of claim 9 wherein creating a platform change document in a platform change business object includes indicating a type of modification in the platform change document.

13. The method of claim 9 wherein creating a platform change document in a platform change business object includes placing old information in the platform change document.

14. The method of claim 13 wherein creating a platform change document in a platform change business object includes placing new information in the platform change document.

15. The method of claim 9 wherein creating a platform change document in a platform change business object includes placing a date associated with a change in the platform change document.

16. The method of claim 9 wherein creating a platform change document in a platform change business object includes placing comments for the change in the platform change document.

17. A machine-readable medium including a set of instructions that when executed by a machine perform the method of claim 9.

18. A platform change apparatus comprising a mechanism for detecting changes in a general business object and automatically recording the changes in a platform change business object.

19. The platform change apparatus of claim 18 wherein the platform change business object includes a platform change document related to a change in the business object.

20. The platform change apparatus of claim 18 wherein the platform change business object stores the changes to the general business object.
